(19) United States
(12) Patent Application Publication
(10) Pub. No.: US 2024/0267851 A1
(43) Pub. Date: Aug. 8, 2024

(54) UPLINK TRANSMIT POWER CONTROL

(71) Applicant: NOKIA SOLUTIONS AND NETWORKS OY, Espoo (FI)

(72) Inventors: István Zsolt KOVÁCS, Aalborg (DK); Klaus Ingemann PEDERSEN, Aalborg (DK); Jian SONG, Palaiseau (FR); Muhammad Majid BUTT, Palaiseau (FR)

(21) Appl. No.: 18/567,199

(22) PCT Filed: Jun. 20, 2022
(86) PCT No.: PCT/FI2022/050435

§ 371 Date: Dec. 5, 2023

(30) Foreign Application Priority Data
Jun. 21, 2021 (FI) 20215727

(51) Int. Cl. H04W 52/14; H04B 17/318; H04W 24/08; H04W 52/24

(52) U.S. Cl. CPC H04W 52/146; H04B 17/328; H04W 24/08; H04W 52/242

(57) ABSTRACT

According to an example embodiment, a network node device is configured to generate at least one client cluster comprising at least one client device served by the network node device according to at least one clustering criterion; assign the at least one control algorithm instance to the at least one client cluster; control at least one transmission power control parameter of the at least one client device in the at least one client cluster using the at least one control algorithm instance.

### TECHNICAL FIELD

The present application generally relates to the field of wireless communications. In particular, the present application relates to a network node device, a related method and computer program.

### BACKGROUND

Transmit power control (TPC) is of high importance in wireless communication. The role of TPC is twofold: it can ensure good reception quality from the client device at the serving cell and it can minimize the generated interference towards neighbouring cells. As was the case for 4G long-term evolution (LTE), 5G NR relies on open loop power control (OLPC), managed through the setting of two primary parameters, namely the path-loss compensation factor and the normalized transmit power density. The selection of TPC parameters is non-trivial and depends on many factors. The optimal OLPC parameter configuration depends on the offered load of the system, on type of traffic, system-bandwidth, scheduling algorithms, number of base stations receive antennas and receiver type, etc.

### SUMMARY

The scope of protection sought for various example embodiments of the disclosure are set out by the independent claims. The example embodiments and features, if any, described in this specification that do not fall under the scope of the independent claims are to be interpreted as examples useful for understanding various example embodiments.

An example embodiment of a network node device comprises at least one processor and at least one memory comprising computer program code. The at least one memory and the computer program code are configured to, with the at least one processor, cause the network node device to: generate at least one client cluster comprising at least one client device served by the network node device according to at least one clustering criterion; assign the at least one control algorithm instance to the at least one client cluster; control at least one transmission power control parameter of the at least one client device in the at least one client cluster using the at least one control algorithm instance; wherein the at least one control algorithm instance is configured to, in each iteration, when in an exploration mode: change at least one transmission power control parameter of at least one client device in the at least one client cluster, monitor a change in at least one performance indicator of the at least one client device in response to the change, and update a policy according to the change in at least one performance indicator; and wherein the at least one control algorithm instance is configured to, when in an exploitation mode, iteratively change the at least one transmission power control parameter of at least one client device in the at least one client cluster according to the policy. The network node device can, for example, independently control the at least one transmission power control parameter of each client cluster.

An example embodiment of a network node device comprises means for performing: generate at least one client cluster comprising at least one client device served by the network node device according to at least one clustering criterion; assign the at least one control algorithm instance to the at least one client cluster; control at least one transmission power control parameter of the at least one client device in the at least one client cluster using the at least one control algorithm instance; wherein the at least one control algorithm instance is configured to, in each iteration, when in an exploration mode: change at least one transmission power control parameter of at least one client device in the at least one client cluster, monitor a change in at least one performance indicator of the at least one client device in response to the change, and update a policy according to the change in at least one performance indicator; and wherein the at least one control algorithm instance is configured to, when in an exploitation mode, iteratively change the at least one transmission power control parameter of at least one client device in the at least one client cluster according to the policy.

In an example embodiment, alternatively or in addition to the above-described example embodiments, the at least one transmission power control parameter comprises normalized transmit power density and/or a path-loss compensation factor. The network node device can, for example, efficiently control the normalized transmit power density and/or a path-loss compensation factor.

In an example embodiment, alternatively or in addition to the above-described example embodiments, the at least one clustering criterion comprises a quality of service and/or radio conditions of the at least one client device. The network node device can, for example, efficiently cluster the client devices based on a quality of service and/or radio conditions.

In an example embodiment, alternatively or in addition to the above-described example embodiments, the at least one clustering criterion comprises a reference signal received power of the at least one client device. The network node device can, for example, efficiently cluster the client devices based on the reference signal received power.

In an example embodiment, alternatively or in addition to the above-described example embodiments, the at least one clustering criterion comprises a reference signal received power, RSRP, difference metric of the at least one client device, wherein the RSRP difference metric comprises a difference between an RSRP received by the at least one client device from the network node device and an RSRP received by the at least one client device from another network node device. The network node device can, for example, efficiently cluster the client devices based on the reference signal received power difference metric.

In an example embodiment, alternatively or in addition to the above-described example embodiments, the at least one control algorithm instance comprises a plurality of control algorithm instances configured to coordinate with each other the changes in the at least one transmission power control parameter. The network node device can, for example, prevent simultaneous changes in the at least one transmission power control parameter in different control algorithm instances.

In an example embodiment, alternatively or in addition to the above-described example embodiments, the at least one control algorithm instance is configured to coordinate the changes in the at least one transmission power control parameter with at least one other control algorithm instance in another network node device. The network node device can, for example, prevent simultaneous changes in the at least one transmission power control parameter in different control algorithm instances in different network node devices.

In an example embodiment, alternatively or in addition to the above-described example embodiments, the at least one memory and the computer program code are further configured to, with the at least one processor, cause the network node device to perform the at least one control algorithm in the exploitation mode as long as the at least one performance indicator of the at least one client device is above a preconfigured threshold. The network node device can, for example, execute the exploitation mode until further exploration is needed.

In an example embodiment, alternatively or in addition to the above-described example embodiments, the at least one memory and the computer program code are further configured to, with the at least one processor, cause the network node device to, in response to at least one performance indicator dropping below the pre-configured threshold, check validity of the at least one client cluster. The network node device can, for example, check whether the previously generated client clusters are still valid.

In an example embodiment, alternatively or in addition to the above-described example embodiments, the at least one memory and the computer program code are further configured to, with the at least one processor, cause the network node device to, in response to the at least one client cluster being invalid, re-cluster the at least one client device in the at least one client cluster. The network node device can, for example, efficiently re-cluster the client clusters when re-clustering is needed due to, for example, changes in radio conditions.

In an example embodiment, alternatively or in addition to the above-described example embodiments, the at least one performance indicator comprises a sum of average throughput over the at least one client cluster or throughput in a selected client cluster in the at least one client cluster. The network node device can, for example, efficiently quantify the performance of the client clusters in order to assess the validity of the client clusters.

In an example embodiment, alternatively or in addition to the above-described example embodiments, the at least one client cluster comprises number n client clusters, and wherein the at least one control algorithm instance is configured to perform the exploration mode and the exploitation mode in: a n-dimensional state space wherein each dimension of the state space corresponds to a state of a client cluster in the n client clusters, the state corresponding the at least one transmission power control parameter; and/or a n-dimensional action space, wherein each dimension of the action space corresponds to an action of a client cluster in the n client clusters, the action corresponding to a change of the at least one transmission power control parameter. The network node device can, for example, simultaneously control the at least one transmission power control parameter of n client clusters.

An example embodiment of a method comprises: generating at least one client cluster comprising at least one client device served by a network node device according to at least one clustering criterion; assigning the at least one control algorithm instance to the at least one client cluster; controlling at least one transmission power control parameter of the at least one client device in the at least one client cluster using the at least one control algorithm instance; wherein the at least one control algorithm instance is configured to, in each iteration, when in an exploration mode: change the at least one transmission power control parameter of at least one client device in the at least one client cluster, monitor a change in at least one performance indicator of the at least one client device in response to the change, and update a policy according to the change in at least one performance indicator; and wherein the at least one control algorithm instance is configured to, when in an exploitation mode, iteratively change the at least one transmission power control parameter of at least one client device in the at least one client cluster according to the policy.

An example embodiment of a computer program product comprises program code configured to perform the method according to any of the above network node device related example embodiments, when the computer program product is executed on a computer.

### DESCRIPTION OF THE DRAWINGS

The accompanying drawings, which are included to provide a further understanding of the example embodiments and constitute a part of this specification, illustrate example embodiments and together with the description help to explain the principles of the example embodiments. In the drawings:

FIG. 1 shows an example embodiment of the subject matter described herein illustrating a network node device;

FIG. 2 shows an example embodiment of the subject matter described herein illustrating an example system in which various example embodiments of the present disclosure may be implemented;

FIG. 3 shows an example embodiment of the subject matter described herein illustrating input and output of a reinforcement learning agent;

FIG. 4 shows an example embodiment of the subject matter described herein illustrating a one-dimensional state space;

FIG. 5 shows an example embodiment of the subject matter described herein illustrating a two-dimensional state space and action space;

FIG. 6 shows an example embodiment of the subject matter described herein illustrating a flow chart for selection of the client clusters;

FIG. 7 shows an example embodiment of the subject matter described herein illustrating a flow chart for exploration mode configuration;

FIG. 8 shows an example embodiment of the subject matter described herein illustrating a flow chart for exploitation mode configuration and execution;

FIG. 9 shows an example embodiment of the subject matter described herein illustrating a flow chart for Q-learning;

FIG. 10 shows an example embodiment of the subject matter described herein illustrating simulation results; and

FIG. 11 shows an example embodiment of the subject matter described herein illustrating a method.

Like reference numerals are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present disclosure may be constructed or utilized. The description sets forth the functions of the example and the sequence of steps for constructing and operating the example. However, the same or equivalent functions and sequences may be accomplished by different example embodiments.

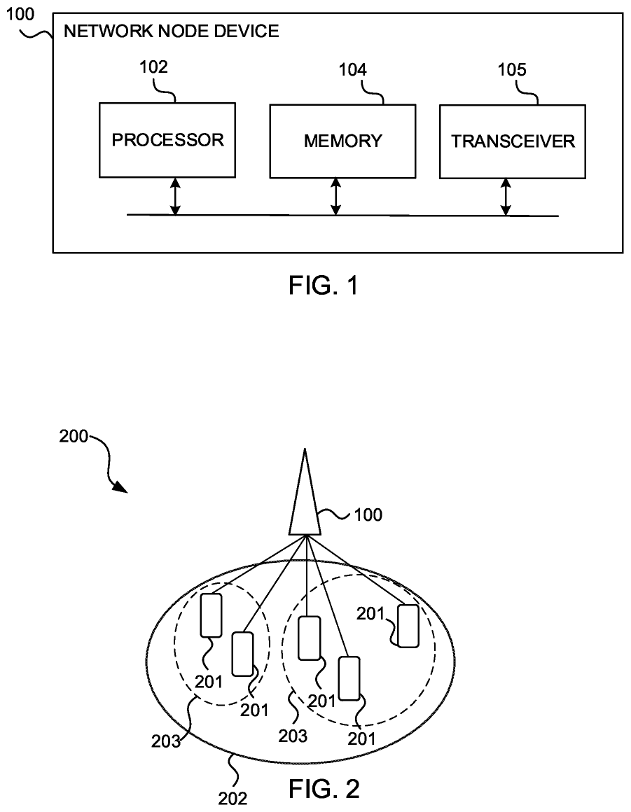

FIG. 1 is a block diagram of a network node device 200 in accordance with an example embodiment.

The network node device 100 comprises one or more processors 102, and one or more memories 104 that comprise computer program code. The network node device 100 may also comprise a transceiver 105, as well as other elements, such as an input/output module (not shown in FIG. 1), and/or a communication interface (not shown in FIG. 1).

According to an example embodiment, the at least one memory 104 and the computer program code are configured to, with the at least one processor 102, cause the network node device 100 generate at least one client cluster comprising at least one client device served by the network node device according to at least one clustering criterion.

Herein, a client device may also be referred to as a client, a user equipment (UE), or similar.

Herein, a client cluster may refer to a group/set of client devices.

The at least one client device can comprise a plurality of client devices.

The network node device 100 may be further configured to assign the at least one control algorithm instance to the at least one client cluster.

The control algorithm may also be referred to as a reinforcement learning (RL) algorithm, a learning algorithm, a time-adaptive learning algorithm, or similar.

The network node device 100 may perform a plurality of control algorithm instances. Each such instance may be performed independently of the other instances. For example, each control algorithm instance may be executed as a separate process. In some example embodiments, the different control algorithm instance may be configured to communicate with each other via, for example, dedicated signalling as disclosed herein.

The at least one client cluster may comprise a plurality of client clusters. Each client cluster may comprise one or more client devices. In each radio cell may comprise one or more client clusters. The client clusters in each radio cell may be controlled by one control algorithm instance or by separate/independent control algorithm instances, of the same control algorithm.

The network node device 100 may be further configured to control at least one transmission power control parameter of the at least one client device in the at least one client cluster using the at least one control algorithm instance.

The at least one transmission power control parameter may comprise, for example, at least uplink open loop power control parameter.

The at least one control algorithm instance may be configured to, in each iteration, when in an exploration mode: change at least one transmission power control parameter of at least one client device in the at least one client device cluster, monitor a change in at least one performance indicator of the at least one client device in response to the change, and update a policy according to the change in at least one performance indicator.

Herein, the performance indicator may also be referred to as a key performance indicator (KPI) or similar.

The at least one control algorithm instance may be configured to, when in an exploitation mode, iteratively change the at least one transmission power control parameter of at least one client device in the at least one client cluster according to the policy.

Herein, the policy may refer to any set of rules according to which the control algorithm instance changes the at least one transmission power control parameter. The policy may comprise, for example, a probability distribution over possible actions of a Markov Decision Process.

According to an example embodiment, the at least one transmission power control parameter comprises normalized transmit power density and/or a path-loss compensation factor.

The network node device 100 can autonomously perform efficient online optimization of transmit power control (TPC) parameters of client devices to achieve good uplink performance under varying conditions, such as varying number of clients, varying radio conditions, traffic conditions, etc.

The network node device 100 can perform smart clustering of the clients within each cell depending on selected system performance indicators.

The network node device 100 can configure the at least one control algorithm instance to dynamically set at least one of the uplink open loop power control parameters (P0 and/or alpha) for clients in the at least one client cluster.

The network node device 100 may configure client cluster specific reward metric to aggregate performance indicators from at least one client device in the client cluster.

The network node device 100 may configure the at least one control algorithm instance to evaluate the configured client cluster specific reward (cost) metric over a finite time-period.

The network node device 100 may adjust the internal parameters of the at least one control algorithm instance based on the outcome of the evaluation of a reward metric/function.

The normalized transmit power density may also be referred to as P0 and the path-loss compensation factor may also be referred to as alpha. Although P0 and/or alpha may be used as examples of the at least one transmission power control parameter in some example embodiments and/or disclosure herein, the disclosure applies also to other possible transmission power control parameters.

Although the network node device 100 may be depicted to comprise only one processor 102, the network node device 100 may comprise more processors. In an example embodiment, the memory 104 is capable of storing instructions, such as an operating system and/or various applications.

Furthermore, the processor 102 is capable of executing the stored instructions. In an example embodiment, the processor 102 may be embodied as a multi-core processor, a single core processor, or a combination of one or more multi-core processors and one or more single core processors. For example, the processor 102 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the processor 102 may be configured to execute hard-coded functionality. In an example embodiment, the processor 102 is embodied as an executor of software instructions, wherein the instructions may specifically configure the processor 102 to perform the algorithms and/or operations described herein when the instructions are executed.

The memory 104 may be embodied as one or more volatile memory devices, one or more non-volatile memory devices, and/or a combination of one or more volatile memory devices and non-volatile memory devices. For example, the memory 104 may be embodied as semiconductor memories (such as mask ROM, PROM (programmable ROM), EPROM (erasable PROM), flash ROM, RAM (random access memory), etc.).

The network node device 100 may be a base station. The base station may comprise, for example, a fifth-generation base station (gNB) or any such device providing an air interface for client devices to connect to the wireless network via wireless transmissions.

Some terminology used herein may follow the naming scheme of 4G or 5G technology in its current form. However, this terminology should not be considered limiting, and the terminology may change over time. Thus, the following discussion regarding any example embodiment may also apply to other technologies, such as 6G.

FIG. 2 illustrates an example system 100 in which various example embodiments of the present disclosure may be implemented. An example representation of the system 200 is shown depicting a plurality of client devices 201 served by a network node device 100.

The network node device 100 can efficiently optimize of uplink client device 201 transmission power control (TPC) using, for example, the normalized transmit power density, also referred to as P0.

Traditionally, P0 has been set to single a value per cell 202 for all client devices 201, and often using the same setting for similar cells. For example, using the same P0 setting for macro cells of similar topology and radio environment. Typically, P0 is only adjusted seldomly, say keeping it constants for hours, days or even weeks. This is clearly a sub-optimal solution.

The network node device 100 can implemented an enhanced method, where intra-RAN online optimization of P0 can be performed using, for example, machine learning (ML) techniques. Each network node device 100 can autonomously adjust its P0 setting to reach a certain objective (optimization criteria). Rather than having only a single common P0 setting for all client 201 in the same cell 202, the network node device 100 can use a smart clustering of clients, where each group of clients can have their own P0 setting.

For example, in the example embodiment of FIG. 2, the client device 201 within a cell 202 have been clustered into two clusters 203.

The network node device 200 can adaptively set P0 and other parameters depending on the client-experienced quality of service (Qos) and their radio conditions in each cell 202. Instead of assuming a single P0 setting for all client devices 201 within the same cell 202, the network node device 100 can smartly cluster clients 201 within each cell 202 and allow different P0 settings per such cluster 203 of clients.

A client device 201 may comprise, for example, a mobile phone, a smartphone, a tablet computer, a smart watch, or any hand-held or portable device or any other apparatus, such as a vehicle, a robot, or a repeater. The client device 201 may also be referred to as a user equipment (UE). The client device 201 may communicate with the network node device 100 via, for example, an air/space born vehicle communication connection, such as a service link.

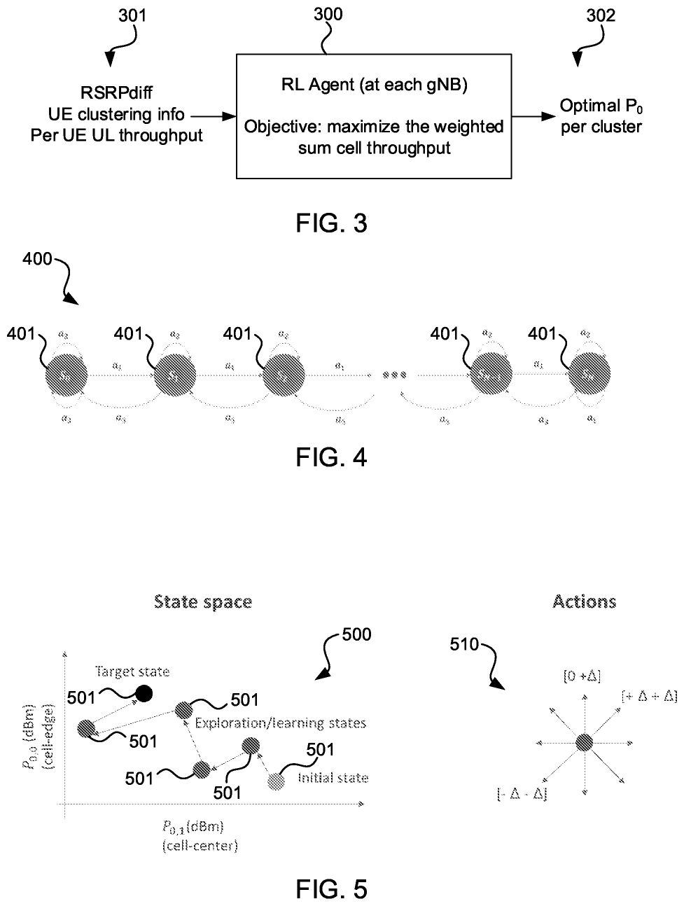

FIG. 3 shows an example embodiment of the subject matter described herein illustrating input and output of a reinforcement learning (RL) agent.

The control algorithm instance can be implemented using, for example an RL agent 300. Each RL-learning agent 300 at each network node device 100 for a given client cluster 203 can have similar inputs 301 and/or outputs 302 as illustrated in the example embodiment of FIG. 3.

The RL-learning agent 300 can take as an input 301, for example, reference signal received power (RSRP) values, client clustering info, and/or per client device uplink throughput information. Based on the input 301, the RL-learning agent 300 can output 302, for example, an optimal P0 value and/or other parameters per cluster.

The input 301 and output 302 data illustrated in the example embodiment of FIG. 3 are only exemplary and the input 301 and output 302 data may be different in different example embodiments.

FIG. 4 shows an example embodiment of the subject matter described herein illustrating a one-dimensional state space.

The one-dimensional state space 400 can be considered a Markov decision process model with N states 401 and three actions. A state 401 may correspond to a current P0 and/or alpha value of a single client cluster and each action can correspond to a change in the P0 and/or alpha value. For example, action a₁ can correspond to increasing P0 by a preconfigured value, a₂ can correspond to maintaining the current P0 value, and a₃ can correspond to decreasing P0 by a preconfigured value. Actions a₁ and a₃ can naturally transition the current state into a different state, while a₂ can maintain the current state. A single client cluster can be controlled by one algorithm instance and each algorithm instance can be considered a process similar to that illustrated in the example embodiment of FIG. 4.

FIG. 5 shows an example embodiment of the subject matter described herein illustrating a two-dimensional state space and action space.

The example embodiment of FIG. 5 illustrates a n-dimensional state space and action space. Each dimension in the n dimensions may correspond to a different client cluster. Thus, such a state space can allow TPC parameter optimization jointly for n different client clusters. In the example embodiment of FIG. 5, n=2.

In the example embodiment of FIG. 5, the x dimension corresponds to a client cluster with client devices in a cell centre while the y dimension corresponds to a client cluster with client devices at a cell edge. Possible actions 510 are illustrated on the right side of FIG. 5, wherein each action corresponds to increasing or decreasing the P0 of one or more of the client clusters by a value Δ dB. Thus, eight different actions are possible. An example of consecutive states 501 due to taking consecutive action 510 are illustrated in the state space 500 of FIG. 5.

According to an example embodiment, the at least one control algorithm instance is configured to perform the exploration mode and the exploitation mode in: a n-dimensional state space wherein each dimension of the state space corresponds to a state of a client cluster in the n client clusters, the state corresponding the at least one transmission power control parameter and/or a n-dimensional action space, wherein each dimension of the action space corresponds to an action of a client cluster in the n client clusters, the action corresponding to a change of the at least one transmission power control parameter.

The network node device 100 can perform a procedure with at least some of the following steps:
0. The network node device 100 can select client clustering criteria. For example, the network node device 100 can estimate, for each client device in a cell, an RSRP difference (log-scale) metric calculated as: RSRPdiff=RSRP_serving−Max (RSRP_neighbours), wherein RSRP_serving refers to the RSRP between the serving network node device and the client device and Max (RSRP_neighbours) refers to a maximum RSRP between a neighbouring network node device and the client device.

According to an example embodiment, the at least one clustering criterion comprises a reference signal received power of the at least one client device.

According to an example embodiment, the at least one clustering criterion comprises an RSRP difference metric of the at least one client device, wherein the RSRP difference metric comprises a difference between an RSRP received by the at least one client device from the network node device and an RSRP received by the at least one client device from another network node device.

In another example, the network node device 100 can estimate the mobility state for each client, and group them such that each client in a given group has similar mobility state, such as low, medium and high.

In yet another example, the network node device 100 can cluster the clients using their quality of service flow settings, based for example on the associated 4G or 5G Qos levels defined in 3GPP, such as ‘GBR’, ‘non-GBR’ and ‘Delay critical GBR’.

In yet another example, the network node device 100 can cluster the clients a combination of the above criteria, for example combining mobility state and RSRP radio condition based conditions to group the clients.
1. The network node device 100 can cluster the client devices into client clusters, using the method selected in step 0. For example, the network node device 100 can use the example metric from step 0. A set of RSRPdiff_threhold parameters can be used to associate each client device to certain client cluster.
2. From the configured client clusters in step 1, the network node device 100 can select the client clusters for which the P0 (and/or alpha) are to be controlled by one or more instances of a control algorithm. The control algorithm can be implemented as a timeadaptive/learning algorithm. The same P0 (and/or alpha) can be set for all client in a given client cluster. The control algorithm can use a selected system key performance indicator (KPI) (cost function, reward function) to monitor the effect of the P0 (and/or alpha) adjustments. The non-selected client cluster (s) can use a fixed, pre-determined P0 (and/or alpha) setting (e.g. from golden rule, or Bayesian optimization).
3. The network node device 100 can determine whether multiple of selected client clusters in Step 2, are to be controlled by the same instance of the control algorithm or if each client cluster is to be controlled by a separate instance of the same control algorithm.
4. The network node device 100 can instantiate the control algorithm based on the outcome of Step 3. Optionally, this step can also include the setup of any required signalling between the control algorithm instances, in the same or different network node devices 100.
5. The network node device 100 can initialize all control algorithm instances from Step 4. For the selected client clusters in step 2, the network node device 100 can initialize the P0 (and/or alpha) to pre-determined values (e.g. form golden rule, or Bayesian optimization). The network node device 100 can initialize the internal parameters and metrics of the control algorithm.
6. The network node device 100 can configure, for each the control algorithm instance, from Step 4-5 the Exploration mode. In Exploration mode, the control algorithm instance can, for each client cluster selected in Step 3, with a certain probability, randomly sets the P0 (and/or alpha) parameter adjustment value for one or more UEs in the client cluster.
7. The network node device 100 can select which clients, from each controlled client cluster, are to be used in the exploration mode.
8. The network node device 100 can execute control algorithm in the exploration mode and keep monitoring the selected system KPI (s) from step 2.
9. The network node device 100 can, while the selected end-criteria in step 6 is not fulfilled, keep executing step 7-9.
10. The network node device 100 can end the exploration mode based on Step 9. Selected internal parameters of the control algorithm can be stored for use in the exploitation mode.
11. The network node device 100 can initialize each control algorithm instance keeping the selected internal parameter values from step 10.
12. The network node device 100 can configure, for each of control algorithm instance from steps 4-5, the exploitation mode.
13. The network node device 100 can execute control algorithm in exploitation mode and keep monitoring the selected system KPI (s) from Step 2. In the execution mode, exploration procedure (e.g. same as in Step 7-9) can be executed, coordinated or not between the different Control algorithm instances.
14. The network node device 100 can, while the selected system KPI (s) do not degrade below pre-determined threshold (s), keep executing steps 13-14.
15. The network node device 100 can end the exploitation mode is based on step 14.
16. The network node device 100 can check validity of client clustering. If the client clusters determined in steps 0-1 are valid, the network node device 100 can continue with Step 5. Otherwise, the network node device 100 can continue with step 0.

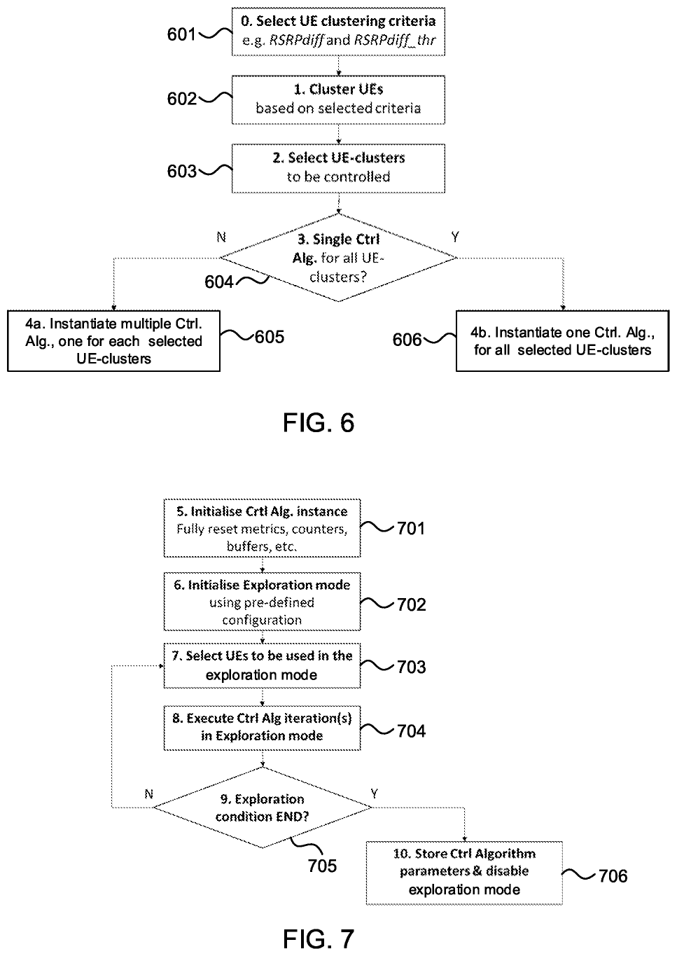

FIG. 6 shows an example embodiment of the subject matter described herein illustrating a flow chart for selection of the client clusters.

The selection of the system KPI to be used can determine both the target of the control algorithm and how the effectiveness of the control algorithm is quantified. Thus this KPI can also be considered a reward/cost function for the control algorithm. The KPI can comprise, for example, a function, such as a weighted sum, of the average aggregated throughputs across all client clusters. The throughput aggregation can be performed linearly (sum/average) or geometrically (for fairness). In the case of cell level aggregation, an optimal weighting factor can be used to scale the throughputs of each client cluster. Alternatively or additionally, the KPI can comprise client device throughput in selected client cluster (s).

According to an example embodiment, the at least one performance indicator comprises a sum of average throughput over the at least one client cluster or throughput in a selected client cluster in the at least one client cluster.

The control algorithm can use a state space defined by the P0 (and/or alpha) values, quantized with a pre-configured granularity, and the number of client clusters controlled by the control algorithm instance. For example, with a single client cluster for P0 adjustments, the one-dimensional state space quantization can be Δ=N dB, where N can be, for example, 1, 2, or any other value.

The control algorithm can use an action space defined based on the P0 (and/or alpha) adjustments steps, and the choice of the state space. For example, with a single client cluster for P0 adjustments, the one-dimensional action space can be defined as {+Δ, 0, −4}.

The state space and action space can be multidimensional (n-D), with the number of dimensions k equal to the number of client clusters controlled by the same control algorithm instance.

In operation 601, the network node device 100 can select client clustering criteria.

In operation 602, the network node device 100 can cluster the client devices according to the clustering criteria.

In operation 603, the network node device 100 can select client clusters to be controlled by the control algorithm. This can be done, based on, for example, the type of system KPI selected. For example, the client cluster with the lowest expected throughputs can be selected, or the client clusters based on the percentile client throughput.

In operation 604, the network node device 100 can choose whether a single control algorithm instance should control all clusters or if a separate control algorithm instance should control each cluster. In the former case, the network node device 100 may perform operation 606, and in the latter case, the network node device 100 may perform operation 605.

According to an example embodiment, the network node device 100 is configured to select and update client clusters based on estimated client throughputs (cell centre, cell edge, percentile of average cell throughput), client device quality of service (QOS) requirements (latency, reliability), client device service type (eMBB, IoT, URLLC), client device geographical location within the radio coverage are of the base station (sector, beam), and/or client device mobility state (low/no, high mobility).

According to an example embodiment, the control algorithm is configured to adjusts the power control parameters P0 and/or alpha using a n-dimensional state space and/or a n-dimensional action space, where each dimension corresponds to one client cluster in the same cell.

According to an example embodiment, the at least one control algorithm instance comprises a plurality of control algorithm instances configured to coordinate with each other the changes in the at least one transmission power control parameter.

According to an example embodiment, the at least one control algorithm instance is configured to coordinate the changes in the at least one transmission power control parameter with at least one other control algorithm instance in another network node device.

In operation 605, when the designed operation of the control algorithm requires coordination between some/all of control algorithm instances, the network node device 100 can configure and initiate the inter-instance signalling mechanism is. For example, the coordination can be intra-gNB. The coordination can be in time-domain with well-defined time periods when each of the control algorithm instance adjusts the P0 such that simultaneous adjustments by different instances are avoided. Coordination can also be inter-gNB. This can require, for example, Xn signalling. For example, the coordination can be in time-domain as in case of intra-gNB, just with longer time periods. The coordination can also be intra-gNB and inter-gNB.

FIG. 7 shows an example embodiment of the subject matter described herein illustrating a flow chart for exploration mode configuration.

In operation 701, the network node device 100 can initialize a control algorithm instance. This may comprise, for example, resetting metrics, counters, and buffers of the control algorithm instance.

In operation 702, the network node device 100 can initialize exploration mode of a control algorithm instance. The network node device 100 can perform the initialization using, for example, a pre-defined configuration.

The exploration mode can use the inter-instance coordination (if any) configured as disclosed herein.

The exploration mode can be configured to change the P0 (and/or alpha) settings of all clients in a given client cluster, or only for certain clients nominated for exploration purposes. These may be referred to as probe clients. The latter solution can reduce the risk of negatively impacting overall system performance.

In operation 703, the network node device 100 can select client devices to be used in the exploration phase.

In operation 704, the network node device 100 can execute control algorithm iterations in the exploration phase.

In operation 705, the network node device 100 can check whether an exploration condition has expired. If the exploration condition has not expired, the network node device can move to operation 703. If the exploration condition has expired, the network node device can move to operation 706.

The exploration condition can be configured as, for example, an exploration time period. The exploration time period can be configured, as the time during which the algorithm monitors the system KPI, while setting P0 (and/or alpha) from a given range of possible values.

The exploration time period can be pre-determined, for example as a number of algorithm iterations, or can be based on the convergence/stability of a selected system metric, such as temporal-difference, throughput variations vs. time, etc.

The exploration time period can also be determined by the inter-instance coordination mechanism disclosed herein.

In operation 706, the network node device 100 can store control algorithm parameters and disable the exploration mode.

According to an example embodiment, each instance of the control algorithm is configured to execute periodically, or when triggered, a coordination procedure with the other instances of the same control algorithm. The other instances of the control algorithm can run in the same or different network node devices 100. The coordination procedure can include at least a time-domain interleaving of the time periods when each instance of the control algorithms adjusts the P0 and/or alpha in their assigned client clusters.

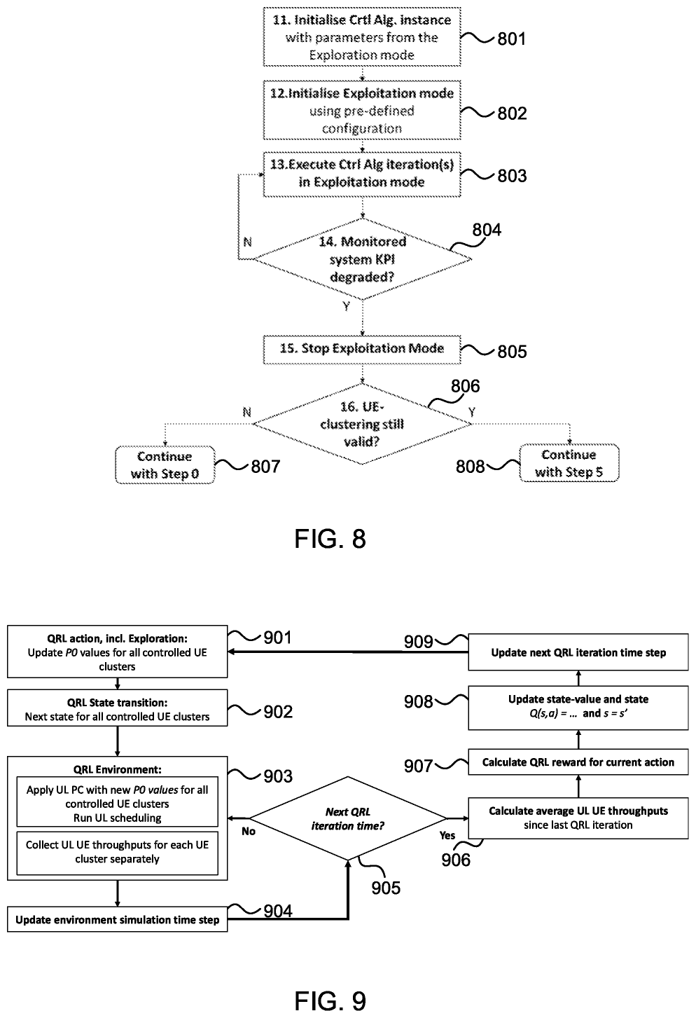

FIG. 8 shows an example embodiment of the subject matter described herein illustrating a flow chart for exploitation mode configuration and execution.

In operation 801, the network node device 100 can initialise the control algorithm instance with parameters from the exploration mode.

In operation 802, the network node device 100 can initialise the exploitation mode using, for example, a pre-defined configuration.

In operation 803, the network node device 100 can execute control algorithm iterations in the exploitation mode.

In operation 804, the network node device 100 can monitor whether system KPI has degraded below a preconfigured threshold. If the KPI has not degraded, the network node device 100 can move to operation 803. If the KPI has degraded, the network node device 100 can move to operation 805.

In operation 805, the network node device 100 can stop the exploitation mode.

In the exploitation mode, the control algorithm can monitor the system KPI for certain P0 (and/or alpha) settings. When the system KPI falls below a certain threshold (or is outside a certain range) the exploitation mode can be ended.

In operation 806, the network node device 100 can check whether the current client clustering is still valid. If the client clustering is valid, the network node device 100 can move to step 5 disclosed above. If the client clustering is not valid, the network node device 100 can move to step 0 disclosed above.

The control algorithm can check the validity of the client cluster. When significant changes are detected, then the network node device can move to operation 807 and restart the procedure from Step 0. Otherwise, the network node device 100 can move to operation 808 and continue the procedure from step 5.

According to an example embodiment, the network node device is further configured to perform the at least one control algorithm in the exploitation mode as long as the at least one performance indicator of the at least one client device is above a preconfigured threshold.

According to an example embodiment, the network node device is further configured to, in response to at least one performance indicator dropping below the preconfigured threshold, check validity of the at least one client cluster.

According to an example embodiment, the network node device is further configured to, in response to the at least one client cluster being invalid, re-cluster the at least one client device in the at least one client cluster.

In the exploitation mode, with low periodicity and/or probability the exploration mode can also be executed. The exploration actions can be performed the same way as in step 8-9 disclosed above, potentially using a different set of probe client devices. The exploration can also be configured to be triggered under certain system conditions such as detected throughput degradation, client mobility, changing client clusters, etc.

According to an example embodiment, each instance of the control algorithm is configured to monitor periodically, or when triggered, the validity of the assigned client cluster (s). A client cluster can be determined to be invalid when, for example, the number of client in the cluster has changed beyond certain limits, and/or the aggregated client performance metric of the client cluster has changed beyond certain limits. When the assigned client cluster is determined to be invalid, the network node device 100 can restart the client clustering procedure and re-instantiate the control algorithms based on the new client clusters.

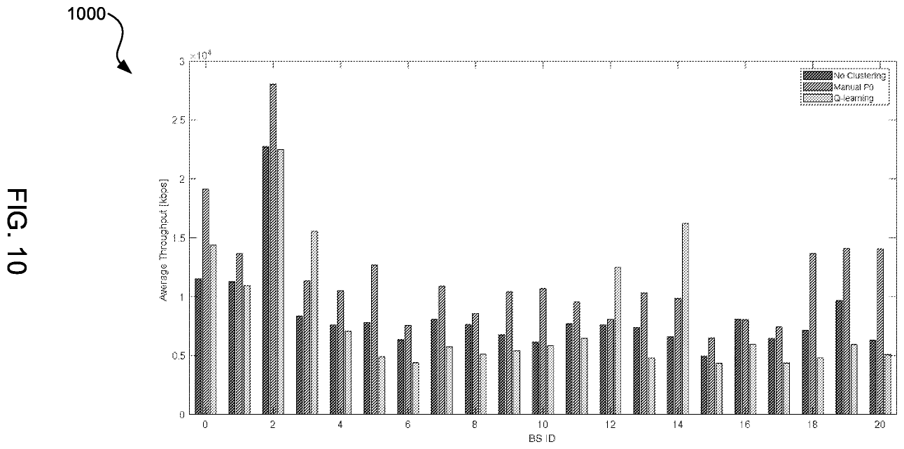

FIG. 9 shows an example embodiment of the subject matter described herein illustrating a flow chart for Q-learning.

In the example embodiment of FIG. 9, the control algorithm is implemented using a Q-learning algorithm. For simplicity, the initialisation phase is not depicted in the example embodiment of FIG. 9. The network node device 100 may implement the control algorithm using Q-learning.

In operation 901, a Q-learning action from the possible exploration actions can be performed and P0 can be updated for all client clusters based on the performed action.

In operation 902, the control algorithm can transition into a new state for all client clusters.

In operation 903, uplink power control with the new P0 value can be applied for all controlled client clusters, uplink scheduling can be run, and uplink client throughputs for each client cluster can be collected separately.

In operation 904, environment simulation time step can be updated.

In operation 905, it can be checked whether the procedure should move to the next Q-learning iteration time step. If not, the procedure can move to operation 903, otherwise the procedure can move to operation 906.

In operation 906, the average uplink client throughput since the last Q-learning iteration can be calculated.

In operation 907, Q-learning reward can be calculated for the current action.

In operation 908, the current state value and state can be updated.

In operation 909, the next Q learning iteration time step can be updated and the procedure can move to operation 901.

FIG. 10 shows an example embodiment of the subject matter described herein illustrating simulation results 1000.

In the simulations, the proposed scheme was implemented using Q-learning and evaluated using a dynamic system-level simulator. The Q-learning algorithm is used to control the P0 setting for a client cluster. The client cluster is determined using the RSRPdiff metric disclosed above and a corresponding threshold. One instance of the same Q-learning algorithm can be used in each network node device 100 to control one client cluster.

In the simulations, the initial exploration mode used a high exploration probability and was terminated after a pre-set time period (number of iterations). The system performance was s evaluated in terms of average cell throughput. The reward function also reflects this system KPI.

FIG. 10 show the achieved average UL cell throughputs for each of the simulated cells (BS0 to BS20) vs. the three different methods used to set the P0 value for a single UE-cluster in each cell (cluster with RSRP difference below 4 dB): ‘golden’ setting (no clustering, same for all cells); manually optimized P0 value for each client cluster (same for all cells); Q-learning as a control algorithm adjusting the P0 value for the cell-edge client cluster (Q-learning, one-dimensional state/action space, independently for each cell).

Performing optimization of TPC parameters on multiple clusters (allowing different TPC settings per cluster) can offer clear benefits.

The implemented Q-learning solution is confirmed to apply potentially different TPC parameters in each cell as per the differences in their radio conditions. For example, client location and experienced interference footprint can affect the radio conditions.

The solution converges nicely and appears to be stable under the tested simulation scenarios. This can be confirmed by, for example, monitoring how the so-called temporal difference evolve over time, and also how other metrics, such as state value, Q-value, Reward and P0 setting, vary as functions of time.

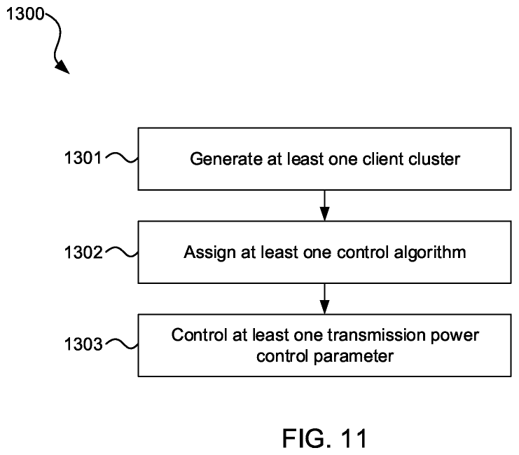

FIG. 11 shows an example embodiment of the subject matter described herein illustrating a method 1300.

According to an example embodiment, the method 1300 comprises generating 1301 at least one client cluster comprising at least one client device served by a network node device according to at least one clustering criterion.

The method 1300 may further comprise assigning 1302 the at least one control algorithm instance to the at least one client cluster.

The method 1300 may further comprise controlling 1303 at least one uplink open loop power control parameter of the at least one client device in the at least one client cluster using the at least one control algorithm instance.

The at least one control algorithm instance may be configured to, in each iteration, when in an exploration mode: change at least one transmission power control parameter of at least one client device in the at least one client cluster, monitor a change in at least one performance indicator of the at least one client device in response to the change, and update a policy according to the change in at least one performance indicator.

The at least one control algorithm instance may be configured to, when in an exploitation mode, iteratively change the at least one transmission power control parameter of at least one client device in the at least one client cluster according to the policy.

It is to be understood that the order in which operations 1301-1303 are performed, may vary from the example embodiment depicted in FIG. 11.

The method 1300 may be performed by the network node device 100 of FIG. 1. Further features of the method 1300 directly result from the functionalities and parameters of the network node device 100. The methods 1300 can be performed, at least partially, by computer program (s).

At least some example embodiments disclosed here can an efficient autonomous configure client TPC settings to achieve good uplink performance, given the specific radio conditions in each network node device (cell). The solution can be adaptive, so client TPC settings can be are adjusted if the network conditions (e.g. location of users, load, experienced inter-cell interference level) changes. This can avoid the tedious “manual” parameter tunning of TPC parameter without adapting to time-variant variations of the network conditions. The fact that the solution can perform TPC parameter optimization on cluster resolution, rather than on per cell basis, can offer clear performance advantages as well.

At least some example embodiments disclosed here can allow for flexible configuration of any ML/RL-driven algorithm as the control algorithm, such as State-Action-Reward-State-Action (SARSA), Deep QL, combination of Deep Neural Networks (DNN)/Long Short Term Model (LSTM) and RL, etc.

At least some example embodiments disclosed here can, via the client clustering, allow for service/traffic type, geolocation, mobility state, selection of the clients or client clusters to be controlled by the network node device 100.

At least some example embodiments, may also applicable in scenarios where specific type of client devices need to be differentiated, such as unmanned aerial vehicles (UAV) or vehicle-to-everything (V2X).

An apparatus may comprise means for performing any aspect of the method (s) described herein. According to an example embodiment, the means comprises at least one processor, and memory comprising program code, the at least one processor, and program code configured to, when executed by the at least one processor, cause performance of any aspect of the method.

The functionality described herein can be performed, at least in part, by one or more computer program product components such as software components. According to an example embodiment, the network node device 100 comprises a processor configured by the program code when executed to execute the example embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and Graphics Processing Units (GPUs).

Any range or device value given herein may be extended or altered without losing the effect sought. Also any example embodiment may be combined with another example embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one example embodiment or may relate to several example embodiments. The example embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the example embodiments described above may be combined with aspects of any of the other example embodiments described to form further example embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various example embodiments have been described above with a certain degree of particularity, or with reference to one or more individual example embodiments, those skilled in the art could make numerous alterations to the disclosed example embodiments without departing from the spirit or scope of this specification.

1. A network node device, comprising:
at least one processor; and
at least one memory including computer program code;
the at least one memory and the computer program code configured to, with the at least one processor, cause the network node device to:
generate at least one client cluster comprising at least one client device served by the network node device according to at least one clustering criterion;
assign the at least one control algorithm instance to the at least one client cluster; and
control at least one transmission power control parameter of the at least one client device in the at least one client cluster using the at least one control algorithm instance,
wherein the at least one control algorithm instance is configured to, in each iteration, when in an exploration mode: change the at least one transmission power control parameter of at least one client device in the at least one client cluster, monitor a change in at least one performance indicator of the at least one client device in response to the change, and update a policy according to the change in at least one performance indicator,
and wherein the at least one control algorithm instance is configured to, when in an exploitation mode, iteratively change the at least one transmission power control parameter of at least one client device in the at least one client cluster according to the policy.

2. The network node device according to claim 1, wherein the at least one transmission power control parameter comprises normalized transmit power density and/or a path-loss compensation factor.

3. The network node device according to claim 1, wherein the at least one clustering criterion comprises a quality of service and/or radio conditions of the at least one client device.

4. The network node device according to claim 1, wherein the at least one clustering criterion comprises reference signal received power of the at least one client device.

5. The network node device according to claim 1, wherein the at least one clustering criterion comprises a reference signal received power, RSRP, difference metric of the at least one client device, wherein the RSRP difference metric comprises a difference between an RSRP received by the at least one client device from the network node device and an RSRP received by the at least one client device from another network node device.

6. The network node device according to claim 1, wherein the at least one control algorithm instance comprises a plurality of control algorithm instances configured to coordinate with each other the changes in the at least one transmission power control parameter.

7. The network node device according to claim 1, wherein the at least one control algorithm instance is configured to coordinate the changes in the at least one transmission power control parameter with at least one other control algorithm instance in another network node device.

8. The network node device according to claim 1, wherein the at least one memory and the computer program code are further configured to, with the at least one processor, cause the network node device to perform the at least one control algorithm in the exploitation mode as long as the at least one performance indicator of the at least one client device is above a preconfigured threshold.

9. The network node device according to claim 8, wherein the at least one memory and the computer program code are further configured to, with the at least one processor, cause the network node device to, in response to at least one performance indicator dropping below the preconfigured threshold, check validity of the at least one client cluster.

10. The network node device according to claim 8, wherein the at least one memory and the computer program code are further configured to, with the at least one processor, cause the network node device to, in response to the at least one client cluster being invalid, re-cluster the at least one client device in the at least one client cluster.

11. The network node device according to claim 1, wherein the at least one performance indicator comprises a sum of average throughput over the at least one client cluster or throughput in a selected client cluster in the at least one client cluster.

12. The network node device according to claim 1, wherein the at least one client cluster comprises number n client clusters, and wherein the at least one control algorithm instance is configured to perform the exploration mode and the exploitation mode in:
a n-dimensional state space wherein each dimension of the state space corresponds to a state of a client cluster in the n client clusters, the state corresponding the at least one transmission power control parameter; and/or
a n-dimensional action space, wherein each dimension of the action space corresponds to an action of a client cluster in the n client clusters, the action corresponding to a change of the at least one transmission power control parameter.

13. A method comprising:
generating at least one client cluster comprising at least one client device served by a network node device according to at least one clustering criterion;
assigning the at least one control algorithm instance to the at least one client cluster;
controlling at least one transmission power control parameter of the at least one client device in the at least one client cluster using the at least one control algorithm instance;
wherein the at least one control algorithm instance is configured to, in each iteration, when in an exploration mode: change the at least one transmission power control parameter of at least one client device in the at least one client cluster, monitor a change in at least one performance indicator of the at least one client device in response to the change, and update a policy according to the change in at least one performance indicator;
and wherein the at least one control algorithm instance is configured to, when in an exploitation mode, iteratively change the at least one transmission power control parameter of at least one client device in the at least one client cluster according to the policy.

14. A non-transitory computer-readable medium comprising computer program instructions encoded thereon, said computer program instructions comprising program code configured to perform the method according to claim 13, when the computer program instructions are executed on a computer.

15. The method according to claim 14, wherein the at least one transmission power control parameter comprises normalized transmit power density and/or a path-loss compensation factor.

16. The method according to claim 14, wherein the at least one clustering criterion comprises a quality of service and/or radio conditions of the at least one client device.

17. The method according to claim 14, wherein the at least one clustering criterion comprises reference signal received power of the at least one client device.

18. The method according to claim 14, wherein the at least one clustering criterion comprises a reference signal received power, RSRP, difference metric of the at least one client device, wherein the RSRP difference metric comprises a difference between an RSRP received by the at least one client device from the network node device and an RSRP received by the at least one client device from another network node device.

19. The method according to claim 14, wherein the at least one control algorithm instance comprises a plurality of control algorithm instances configured to coordinate with each other the changes in the at least one transmission power control parameter.

20. The method according to claim 14, wherein the at least one control algorithm instance is configured to coordinate the changes in the at least one transmission power control parameter with at least one other control algorithm instance in another network node device.
